(19) United States
(12) Patent Application Publication
(10) Pub. No.: US 2026/0287760 A1
(43) Pub. Date: Sep. 24, 2026

(54) X-RAY DOSE MANAGEMENT

(71) Applicant: Baker Hughes Holdings LLC, Houston, TX (US)

(72) Inventors: Li LI, Shanghai (CN); HIlgendorg SEBASTIAN, Hamburg (DE); Li JING, Shanghai (CN)

(21) Appl. No.: 19/473,692

(22) PCT Filed: Apr. 10, 2023
(86) PCT No.: PCT/CN2023/087224

§ 371 Date: Oct. 8, 2025

(51) Int. Cl. G01T 1/02; G01N 23/04; G01N 23/083

(52) U.S. Cl. CPC G01T 1/02; G01N 23/04; G01N 23/083; G01N 2223/3303

(57) ABSTRACT

A non-transitory computer readable memory storing instructions, which, when executed by at least one data processor, causes the at least one data processor to perform the following operations. A first set of data characterizing a sample being examined with a radiation source and a detector is received. The first set of data includes a location of the sample and a duration of time the sample is at the location. A second set of data characterizing radiation dosage based on location is received. A dosage across the sample is determined based on the first set of data and the second set of data. A third set of data characterizing radiation dosage across the sample based on the determined dosage is provided.

### TECHNICAL FIELD

The disclosure relates to technologies for dose management to protect samples from excess x-ray radiation.

### BACKGROUND

X-ray inspection of components during production is often used to ensure production quality. X-ray inspection of components is also common during routine maintenance and inspection plans, and is commonly used in root-cause-failure analysis investigations. In some instances, components are x-ray inspected within an x-ray scanner in a controlled environment. Such x-ray scanners include an x-ray source, an x-ray detector, and a sample platform on which the components rest during inspection. In some situations, the x-ray detector acts as a sample platform.

Certain components subjected to x-ray scanning can be damaged by the x-ray source if the x-ray dosage exceeds a certain threshold. Such components include Dynamic Random Access Memory (DRAM) chips, photographic film, and other components.

### SUMMARY

This disclosure relates to x-ray dose management.

An example implementation of the subject matter described within this disclosure is a system with the following features. A non-transitory memory sores instructions, which, when executed by at least one data processor, causes the at least one data processor to perform the following operations. A first set of data characterizing a sample being examined with a radiation source and a detector is received. The first set of data includes a location of the sample and a duration of time the sample is at the location. A second set of data characterizing radiation dosage based on location is received. A dosage across the sample is determined based on the first set of data and the second set of data. A third set of data characterizing radiation dosage across the sample based on the determined dosage is provided.

Aspects of the example system, which can be used with example system alone or with other aspects, include the following. The instructions cause the at least one data processor to perform the following operations. A heat-map is determined based on the third set of data. The heat-map is overlaid over an image of the sample.

Aspects of the example system, which can be used with example system alone or with other aspects, include the following. The instructions cause the at least one data processor to perform the following operations. The radiation dosage is determined to have exceeded a pre-determined level based on the third set of data. An instruction is transmitted to an apparatus examining the sample. The instructions cause the apparatus to cease the examination of the sample in when received by the apparatus.

Aspects of the example system, which can be used with example system alone or with other aspects, include the following. The instructions cause the at least one data processor to perform the following operations. Data measured by a detector and characterizing a radiation dosage at a series of scanning positions within a scanning device is received. The second set of data is constructed based on the received data.

Aspects of the example system, which can be used with example system alone or with other aspects, include the following. The second set of data includes a look-up table.

Aspects of the example system, which can be used with example system alone or with other aspects, include the following. The radiation dosage is determined in part by interpolating values based on the look-up table.

Aspects of the example system, which can be used with example system alone or with other aspects, include the following. The instructions cause the at least one data processor to perform the following operations. A radiation dosage from a second radiation source is measured by the detector at the series of scanning positions within the scanning device. A second look-up table is constructed based on the measured radiation dosage at the series of positions.

Aspects of the example system, which can be used with example system alone or with other aspects, include the following. The instructions cause the at least one data processor to perform the following operations. A sample is examined with the second radiation source and the detector. a dosage across the sample is determined based on the second look-up table and location of the sample.

Aspects of the example system, which can be used with example system alone or with other aspects, include the following. The radiation dosage is determined in-part using the following equation:

$${D}_{2} = {D}_{1} * {( \frac{{FOD}_{1}}{{FOD}_{2}} )}^{2} * \frac{{T}_{2}}{{T}_{1}} * \frac{{P}_{2}}{{P}_{1}}$$

where D₂ is resulting radiation dosage, where D₁ is a base radiation dosage at a base distance from the radiation source, where FOD is the base distance from the radiation source, wherein FOD₂ is an actual distance from the radiation source, T₁ is a base duration of radiation exposure, T₂ is an actual duration of radiation exposure, P₂ is power during scanning operations, P₁ is power used during measurements to create the look-up table.

An example of the subject matter described within this disclosure is a method with the following features. A radiation dosage from a radiation source is measured by a detector at a series of scanning positions within a scanning device. A look-up table is constructed based on the measured radiation dosage at the series of positions. A sample is examined with the radiation source and the detector. A dosage across the sample is determined based on the look-up table and a position of the sample.

Aspects of the example method, which can be combined with the example method alone or in combination with other aspects, include the following. A heat-map is generated based on the determined dosage. The heat-map is overlaid over an image of the sample. The heat-map is displayed over the image of the sample.

Aspects of the example method, which can be combined with the example method alone or in combination with other aspects, include the following. The radiation dosage is determined to have exceeded a pre-determined level based on the third set of data. A scanning operation of the sample is ceased responsive to the dosage exceeding a pre-determined level.

Aspects of the example method, which can be combined with the example method alone or in combination with other aspects, include the following. The sample is removed from the scanning device after operation has been ceased.

Aspects of the example method, which can be combined with the example method alone or in combination with other aspects, include the following. The radiation source is a first radiation source. The look-up table is a first look-up table. The first radiation source is replaced with a second radiation source. A radiation dosage from the second radiation source is measured by the detector at the series of scanning positions within the scanning device. A second look-up table is constructed based on the measured radiation dosage at the series of positions. The second look-up table is different from the first look-up table.

Aspects of the example method, which can be combined with the example method alone or in combination with other aspects, include the following. A sample is examined with the second radiation source and the detector. A dosage across the sample is determined based on the second look-up table and location of the sample.

Aspects of the example method, which can be combined with the example method alone or in combination with other aspects, include the following. Determining the radiation dosage includes interpolating values based on the look-up table.

Aspects of the example method, which can be combined with the example method alone or in combination with other aspects, include the following. Determining the radiation dosage comprises using the following equation:

$${D}_{2} = {D}_{1} * {( \frac{{FOD}_{1}}{{FOD}_{2}} )}^{2} * \frac{{T}_{2}}{{T}_{1}} * \frac{{P}_{2}}{{P}_{1}}$$

where D₂ is resulting radiation dosage, where D₁ is a base radiation dosage at a base distance from the radiation source, where FOD₁ is the base distance from the radiation source, wherein FOD₂ is an actual distance from the radiation source, T₁ is a base duration of radiation exposure, T₂ is an actual duration of radiation exposure, P₂ is power during scanning operations, P₁ is power used during measurements to create the look-up table.

An example implementation of the subject matter described within this disclosure is a non-transitory computer readable memory storing instructions which, when executed by at least one data processor forming part of at least one computing system, causes the at least one data processor to perform the following operations. A radiation dosage from a radiation source is measured by a detector at a series of scanning positions within a scanning device. A look-up table is constructed based on the measured radiation dosage at the series of positions. A sample is examined with the radiation source and the detector. A dosage across the sample is determined based on the look-up table and a position of the sample.

Aspects of the example non-transitory computer readable memory, which can be combined with the example non-transitory computer readable memory alone or in combination with other aspects, include the following. The instructions cause the at least one data processor to perform the following operations. A heat-map is determined based on the determined dosage. The heat-map is overlaid over an image of the sample.

Aspects of the example non-transitory computer readable memory, which can be combined with the example non-transitory computer readable memory alone or in combination with other aspects, include the following. The radiation dosage is determined to have exceeded a pre-determined level based on the third set of data. A scanning operation of the sample is ceased responsive to the dosage exceeding a pre-determined level.

### BRIEF DESCRIPTION OF THE FIGURES

The accompanying drawings, which are incorporated in and constitute a part of this disclosure, show certain aspects of the subject matter disclosed herein and, together with the description, help explain some of the principles associated with the disclosed implementations.

FIG. 1 is a flowchart of a method that can be used with aspects of this disclosure;

FIG. 2 is a block diagram of an example controller that can be used with aspects of this disclosure;

FIG. 3 is a schematic diagram of an example x-ray detector that can be used with aspects of this disclosure; and

FIGS. 4A-4B are example displays that can be used with aspects of this disclosure.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

As various components can be damaged by x-ray inspection when they experience an x-ray dosage above a specified threshold, determining real-time x-ray dosage can reduce a number of parts damaged by such inspections. This disclosure describes creating data, such as a look-up table, characterizing x-ray dosage within an x-ray scanning device. The creation of such data is done by scanning the x-ray detector in various position to determine a dosage distribution within the detector. In some implementations, the data can be stored in a look-up table. Such data can be used to determine a dosage of a part being scanned by the x-ray scanner based on the position of the part within the scanner and a power output of an x-ray source. In some embodiments, the determination is done based on the look-up table and an interpolation equation. If the part reaches a pre-set dosage limit, scanning can be ceased to reduce risk of damaging the scanned part. While primarily described in the context of parts within an x-ray scanner, aspects of this disclosure are similarly applicable to other situations where doses of radiation are administered. For example, the subject matter described herein is applicable to other types of radiation dosing, for example, gamma rays, without departing from this disclosure.

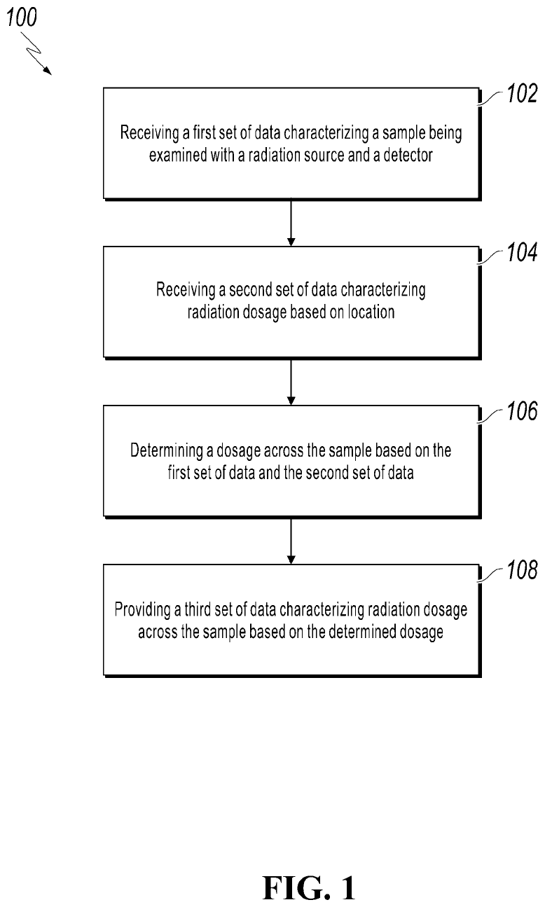

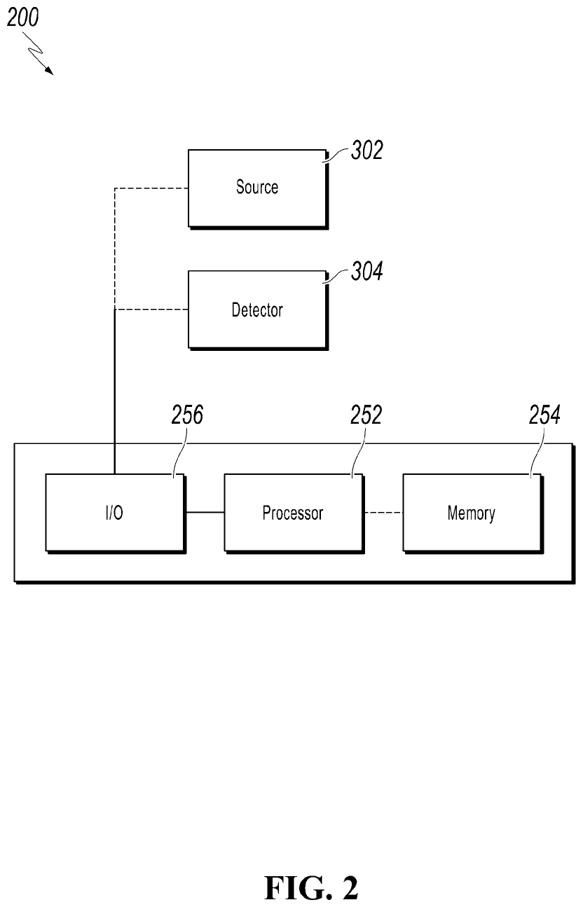

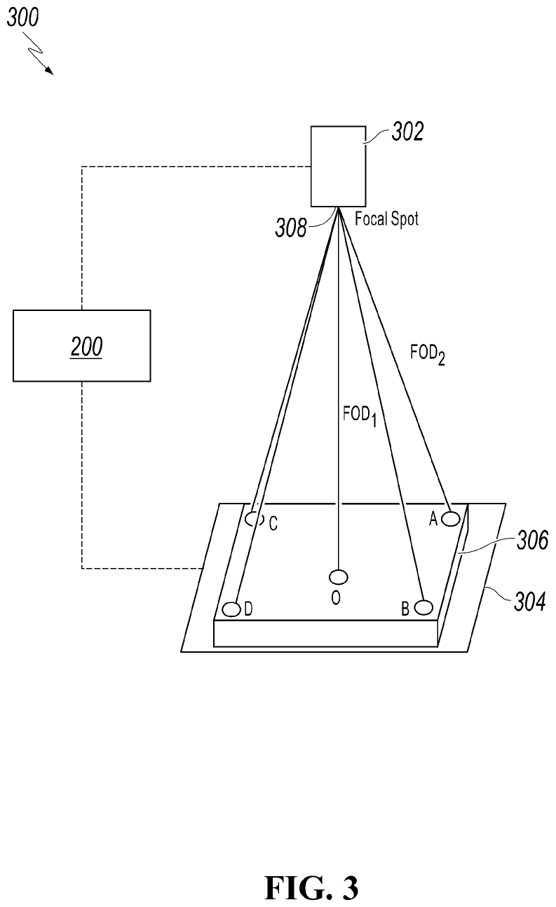

FIG. 1 describes a method 100 that can be used with aspects of this disclosure. All or part of the method 100 can be performed by the controller 200 illustrated in FIG. 2. At 102, a first set of data characterizing a sample being examined with a radiation source and a detector is received. The data includes a location of the sample and a duration of time the sample is at the location. Such data can be received directly from an x-ray scanning system 300, such as the example illustrated in FIG. 3. Such a scanning system 300 includes a radiation source 302 arranged to emit radiation towards a detector 304. During scanning, a sample 306 is located between the radiation source 302 and the detector. The detector 304 then detects an amplitude of radiation that has passed through the sample at a specific point on the sample. The detector then converts the measured amplitude at a series of specific points into data that can be converted into an image representing the sample 306.

Referring back to FIG. 1, At 104, a second set of data characterizing radiation dosage based on location is received. For example, in some instances, a radiation dosage from a radiation source 302 (FIG. 3) is measured, by a detector 304, at a series of scanning positions within a scanning device. In some embodiments, the radiation source 302 is moved to the series of scanning positions. In some embodiments, the detector is moved to the series of scanning positions. In some embodiments, both the detector 304 and the source 302 are moved to the series of scanning positions. In some instances, such data is acquired from the scanner prior to scanning the sample 306. In some embodiments, the second set of data is stored in a look-up table.

At 106, a dosage across the sample 306 (FIG. 3) is determined based on the first set of data and the second set of data. In some implementations, determining the dosage exposed to the sample 306 involves using the following equation:

$${D}_{2} = {D}_{1} * {( \frac{{FOD}_{1}}{{FOD}_{2}} )}^{2} * \frac{{T}_{2}}{{T}_{1}} * \frac{{P}_{2}}{{P}_{1}} \qquad ( 1 )$$

where D₂ is resulting radiation dosage and where D; is a base radiation dosage at a base distance from the radiation source. FOD₁ is a base distance from a focal point 308 of the radiation source 302. More specifically, FOD₁ is the shortest distance between the focal point 308 of the source 302 and the sample 306. FOD₂ is an actual distance from the radiation source, for example, on a non-center portion of the sample 306. T₁ is a base duration of radiation exposure while collecting the second set of data, and T₂ is a duration of radiation exposure while scanning the sample 306. P₂ is a power of the radiation source while scanning the sample, and P₁ is a power used during measurements to create the second dataset. In embodiments where a look-up table is used, D₁, FOD₁, T₁, and P₁ can be included in the look-up table and D₂, FOD₂, T₂, and P₂ are measured or determined during scanning operations. In some embodiments, the equation (1) and values are stored within the memory of the controller 200.

At 108, a third set of data characterizing radiation dosage across the sample is provided based on the determined dosage. In some implementations, the first set of data, for example, the data acquired during the sample scan, is combined with the second set of data, such as the look-up table, to determine a radiation dosage experiences across the sample 306. The radiation dosage experienced across the sample can be expressed as the third dataset and can be produced real-time (within seconds) while scanning operations are ongoing.

Such data can be used, for example to protect samples that are sensitive to radiation dosage, such as DRAM or photographic film. In some instances, the radiation dosage is determined to have exceeded a pre-determined level based on the third set of data. In such an instance, the operation can be ceased by an operator or the controller 200. For example, in some implementations, an instruction can be transmitted, by the controller 200 for example, to the scanning system 300. In such implementations, the instructions can cause the system 300 to cease the examination of the sample 306 in when the instructions are received by the system 300. Ceasing operations can include stopping power transmission to the radiation source 302. Once operations are ceased, the sample 306 can be removed from the scanning device, for example, by an operator or a robotic system controlled by the controller 200.

Focusing on the controller 200 in FIG. 2. The controller 200 can, among other things, monitor parameters of the system 300, send signals to actuate, and/or adjust various operating parameters of such systems. As shown in FIG. 2, the controller 200 can include one or more processors 252 and non-transitory computer readable memory storage (e.g., memory 254) containing instructions that cause the processors 252 to perform operations. The processors 252 are coupled to an input/output (I/O) interface 256 for sending and receiving communications with components in the system, including, for example, the detector 304, the radiation source 302, and/or any movement actuators coupled to each. In certain instances, the controller 200 can additionally communicate status with and send actuation and/or control signals to one or more of the various system components (including, for example, the actuators) of the system 300, as well as other sensors (e.g., radiation sensors, temperature sensors, vibration sensors and other types of sensors) that provide signals to the system 300.

The controller 200 can be implemented with various levels of autonomy. In some implementations, the controller 200 alerts an operator that a parameter is above a specified threshold, for example, radiation dosage of a sample being scanned, and the operator then ceases scanning operations. In some instances, the controller 200 determines that a parameter is above a specified threshold, and ceases scanning operations with no input from the operator.

FIG. 3 is an example scanning system 300 that can be used with aspects of this disclosure. As previously discussed, the radiation source 302 is arranged to emit radiation towards the detector. The sample 306 is arranged between the source 302 and the detector 304. In some embodiments, the controller 200 is coupled to the detector 304 and the radiation source 302. The sample 306 and the detector 304 can be configured to move relative to the source 302. Alternatively or in addition, the source 302 can be configured to move relative to the sample 306 and the detector 304. Regardless of relative movement, the controller 200 can be used to control the relative movement during scanning operations.

Components of the scanning system 300 can be replaced or altered during maintenance, for example, the radiation source 302 can be swapped out with a new radiation source. The new radiation source 302 can be substantially identical to the first radiation source 302, or the new radiation source can have different operational properties (for example, power rating). Regardless, in instances where a new radiation source is installed or the first radiation source is modified, a new scan may be needed to produce a new set of data characterizing the radiation dosage based on location. For example, a radiation dosage from a second radiation source can be measured by the detector 304 at the series of scanning positions within the scanning device. The data collected during measurements can then be stored in a usable format, for example, a new look-up table. A sample 306 can then be examined with the new radiation source and the detector, and a radiation dosage across the sample can be determined based on the new set of data characterizing radiation dosage and a location of the sample during scanning operations.

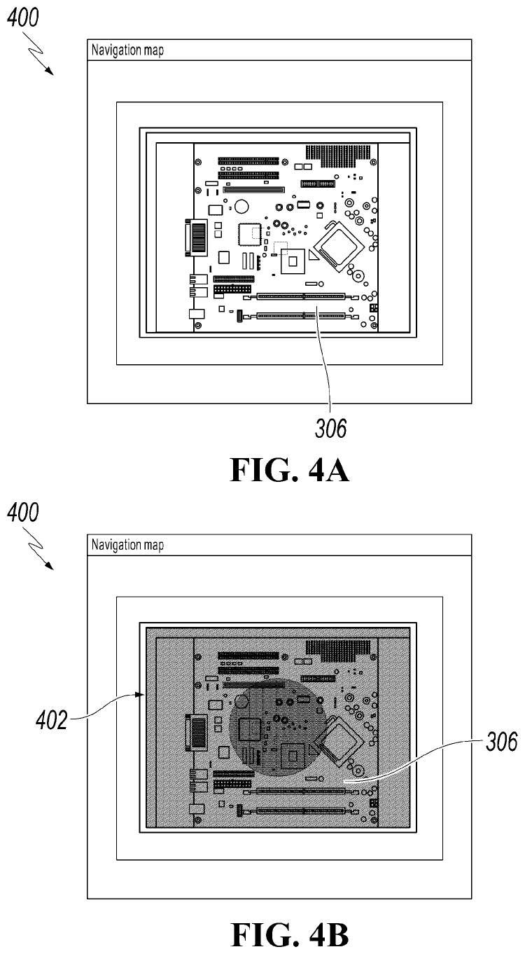

During examination, in some embodiments, the sample 306 can be displayed upon a screen 400 for an operator as shown in FIG. 4A. Such a display can include an actual photograph of the part, a photograph of a representative part, a graphic representing the part, or a live video of the part. In some embodiments, data characterizing the dosage received by the sample 306 can be used to generate or determine a heat-map 402, which can be displayed and overlaid over the image of the part, as shown in FIG. 4B. Such a heat-map 402 allows an operator to see, and in some instances, react to the dosage received by the sample 306.

In some embodiments, source code can be human-readable code that can be written in program languages such as python, C++, etc. In some embodiments, computer-executable codes can be machine-readable codes that can be generated by compiling one or more source codes. Computer-executable codes can be executed by operating systems (e.g., linux, windows, mac, etc.) of a computing device or distributed computing system. For example, computer-executable codes can include data needed to create runtime environment (e.g., binary machine code) that can be executed on the processors of the computing system or the distributed computing system.

Other embodiments are within the scope and spirit of the disclosed subject matter. For example, the method of generating consolidate dataset described in this application can be used in facilities that have complex machines with multiple operational parameters. Usage of the word “optimize”/“optimizing” in this application can imply “improve”/“improving.”

Certain embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an embodiment of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A system comprising:
at least one data processor; and
non-transitory memory storing instructions, which, when executed by the at least one data processor causes the at least one data processor to perform operations comprising:
receiving a first set of data characterizing a sample being examined with a radiation source and a detector, the first set of data comprising a location of the sample and a duration of time the sample is at the location;
receiving a second set of data characterizing radiation dosage based on location; and
determining a dosage across the sample based on the first set of data and the second set of data; and
providing a third set of data characterizing radiation dosage across the sample based on the determined dosage.

2. The system of claim 1, wherein the instructions cause the at least one data processor to perform operations further comprising:
determining a heat-map based on the third set of data; and
overlaying the heat-map over an image of the sample.

3. The system of claim 1, wherein the instructions cause the at least one data processor to perform operations further comprising:
determining the radiation dosage has exceeded a pre-determined level based on the third set of data; and
transmitting an instruction to an apparatus examining the sample, the instructions causing the apparatus to cease the examination of the sample in when received by the apparatus.

4. The system of claim 1, wherein the instructions cause the at least one data processor to perform operations further comprising:
receiving data characterizing a radiation dosage, measured by a detector, at a series of scanning positions within a scanning device; and
constructing the second set of data based on the received data.

5. The system of claim 4, wherein the second set of data comprises a look-up table.

6. The system of claim 5, wherein the radiation dosage is determined in part by interpolating values based on the look-up table.

7. The system of claim 5, wherein the radiation source is a first radiation source, wherein the look-up table is a first look-up table, wherein the instructions cause the at least one data processor to perform operations further comprising:
measuring a radiation dosage from a second radiation source, by the detector, at the series of scanning positions within the scanning device; and
constructing a second look-up table based on the measured radiation dosage at the series of positions.

8. The system of claim 7, wherein the instructions cause the at least one data processor to perform operations further comprising:
examining a sample with the second radiation source and the detector; and
determining a dosage across the sample based on the second look-up table and location of the sample.

9. The system of claim 1, wherein the radiation dosage is determined in-part using the following equation:
$${D}_{2} = {D}_{1} * {( \frac{{FOD}_{1}}{{FOD}_{2}} )}^{2} * \frac{{T}_{2}}{{T}_{1}} * \frac{{P}_{2}}{{P}_{1}}$$
where D₂ is resulting radiation dosage, where D₁ is a base radiation dosage at a base distance from the radiation source, where FOD₁ is the base distance from the radiation source, wherein FOD₂ is an actual distance from the radiation source, T₁ is a base duration of radiation exposure, T₂ is an actual duration of radiation exposure, P₂ is power during scanning operations, P₁ is power used during measurements to create the look-up table.

10. A method comprising:
measuring a radiation dosage from a radiation source, by a detector, at a series of scanning positions within a scanning device;
constructing a look-up table based on the measured radiation dosage at the series of positions;
examining a sample with the radiation source and the detector; and
determining a dosage across the sample based on the look-up table and a position of the sample.

11. The method of claim 10, further comprising:
generating a heat-map based on the determined dosage;
overlaying the heat-map over an image of the sample; and
displaying the heat-map over the image of the sample.

12. The method of claim 10, further comprising:
determining the radiation dosage has exceeded a pre-determined level based on the third set of data; and
ceasing a scanning operation of the sample responsive to the dosage exceeding a pre-determined level.

13. The method of claim 12, further comprising:
removing the sample from the scanning device after operation has been ceased.

14. The method of claim 10, wherein the radiation source is a first radiation source, wherein the look-up table is a first look-up table, the method further comprising:
replacing the first radiation source with a second radiation source;
measuring a radiation dosage from the second radiation source, by the detector, at the series of scanning positions within the scanning device; and
constructing a second look-up table based on the measured radiation dosage at the series of positions, wherein the second look-up table is different from the first look-up table.

15. The method of claim 14, further comprising:
examining a sample with the second radiation source and the detector; and
determining a dosage across the sample based on the second look-up table and location of the sample.

16. The method of claim 10, wherein determining the radiation dosage comprises interpolating values based on the look-up table.

17. The method of claim 10, wherein determining the radiation dosage comprises using the following equation:
$${D}_{2} = {D}_{1} * {( \frac{{FOD}_{1}}{{FOD}_{2}} )}^{2} * \frac{{T}_{2}}{{T}_{1}} * \frac{{P}_{2}}{{P}_{1}}$$
where D₂ is resulting radiation dosage, where D₁ is a base radiation dosage at a base distance from the radiation source, where FOD₁ is the base distance from the radiation source, wherein FOD₂ is an actual distance from the radiation source, T₁ is a base duration of radiation exposure, T₂ is an actual duration of radiation exposure, P₂ is power during scanning operations, P₁ is power used during measurements to create the look-up table.

18. A non-transitory computer readable memory storing instructions which, when executed by at least one data processor forming part of at least one computing system, causes the at least one data processor to perform operations comprising:
measuring a radiation dosage from a radiation source, by a detector, at a series of scanning positions within a scanning device;
constructing a look-up table based on the measured radiation dosage at the series of positions;
examining a sample with the radiation source and the detector; and
determining a dosage across the sample based on the look-up table and a position of the sample.

19. The non-transitory computer readable memory of claim 18, wherein the instructions cause the at least one data processor to perform operations further comprising:
determining a heat-map based on the determined dosage; and
overlaying the heat-map over an image of the sample.

20. The non-transitory computer readable memory of claim 18, wherein the instructions cause the at least one data processor to perform operations further comprising:
determining the radiation dosage has exceeded a pre-determined level based on the third set of data; and
ceasing a scanning operation of the sample responsive to the dosage exceeding a pre-determined level.
